(19) United States
(12) Patent Application Publication
(10) Pub. No.: US 2019/0183094 A1
(43) Pub. Date: Jun. 20, 2019

(54) Leash Carrier Utility Band

(71) Applicant: Leslie Arnett, Cheyenne, WY (US)

(72) Inventor: Leslie Arnett, Cheyenne, WY (US)

(21) Appl. No.: 16/028,587

(22) Filed: Jul. 6, 2018

Related U.S. Application Data
(60) Provisional application No. 62/607,152, filed on Dec. 18, 2017.

(51) Int. Cl. A01K 23/00; A01K 27/00

(52) U.S. Cl. CPC A01K 23/005; A01K 27/005; A01K 27/003; A01K 27/008

(57) ABSTRACT

A device to aid a user in carrying objects when walking a pet. A leash carrier utility band has a top side, a bottom side, a front side, and a back side. One or more straps is disposed on any one side and designed to secure to the opposing side. A bag clip is open at one end and affixed to the bottom side. The bag clip is designed to aid in tying and securing a used pet fecal matter receptacle thereto. A loop is placed opposite the opening of the bag clip and designed to accept a leash therethrough. A bag pouch is on the front side of the body and houses a plurality of unused pet fecal matter receptacles with a bag dispensing aperture on the bag pouch and in communication with the receptacles therein. An alternate pouch is disposed on a back side of the body.

### CROSS REFERENCE TO RELATED APPLICATIONS

This application claims the benefit of U.S. Provisional Application No. 62/607,152 filed on Dec. 18, 2017. The above identified patent application is herein incorporated by reference in its entirety to provide continuity of disclosure.

### BACKGROUND OF THE INVENTION

The present invention relates to hand protection. Specifically, the present invention relates to straps configured to enclose a hand and having dog walking utilities affixed thereto.

When walking a pet, individuals often struggle to control the pet on the leash and pick up pet waste at the same time. This can impede the ability of the pet owner to care for and control their pet and leads to problematic and potentially dangerous situations for the pet owner, such as accidentally losing control of the animal and having it run away. The difficulty in controlling a leash and picking up pet waste with one hand leads to pet owners being less likely to clean up after their pet. Thus, a device is desirable to enable control of a leash while allowing a user to pick up pet waste.

Several devices are known that aide in solving this problem. One such device includes a mitten having a pocket on a dorsal side to house pet fecal matter receptacles. Another device provides a hand covering with an opening at a distal end thereof, wherein a leash can be fed through the aperture. However, these devices fail to provide a leash carrier utility band having a bag opener and a bag clip thereon, thus facilitating both the opening of a new pet fecal matter bag and the securement of an expended pet fecal matter bag.

### SUMMARY OF THE INVENTION

In view of the foregoing disadvantages inherent in the known types of leashes now present in the prior art, the present invention provides a leash carrier utility band wherein the same can be utilized for providing convenience for the user when operating with a single hand. The present device comprises a leash carrier utility band having a top side, a bottom side, a front side, and a back side, wherein one or more straps is disposed on any one side and configured to removably secure via a fastener to the opposing side. A bag clip having an opening at one end is affixed to the bottom side, wherein the bag clip is configured to secure a used pet fecal matter receptacle thereto. A loop is disposed at a distal end of the bag clip, opposite the opening of the bag clip and configured to accept a leash therethrough. A bag pouch is disposed on a front side of the body configured to house a plurality of unused pet fecal matter receptacles with a bag dispensing aperture affixed to an outer surface of the bag pouch and in communication with the receptacles therein. An alternate pouch is disposed on a back side of the body.

Other objects, features, and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a perspective view of a front side of an embodiment of the leash carrier utility band.

FIG. 1B shows a close-up view of an embodiment of the bag opener and bag dispensing aperture on the leash carrier utility band.

FIG. 2A shows a perspective view of a back side of an embodiment of the leash carrier utility band.

FIG. 2B shows a close-up view of the bag clip on the bottom side of the leash carrier utility band.

FIG. 3 shows an elevation view of an alternate embodiment of the leash carrier utility band.

### DETAILED DESCRIPTION OF THE INVENTION

Reference is made herein to the attached drawings. Like reference numerals are used throughout the drawings to depict like or similar elements of the leash carrier utility band. The figures are intended for representative purposes only and should not be considered to be limiting in any respect. Unless specifically limited to a single unit, “a” is intended to be equivalent to “one or more” throughout the present disclosure.

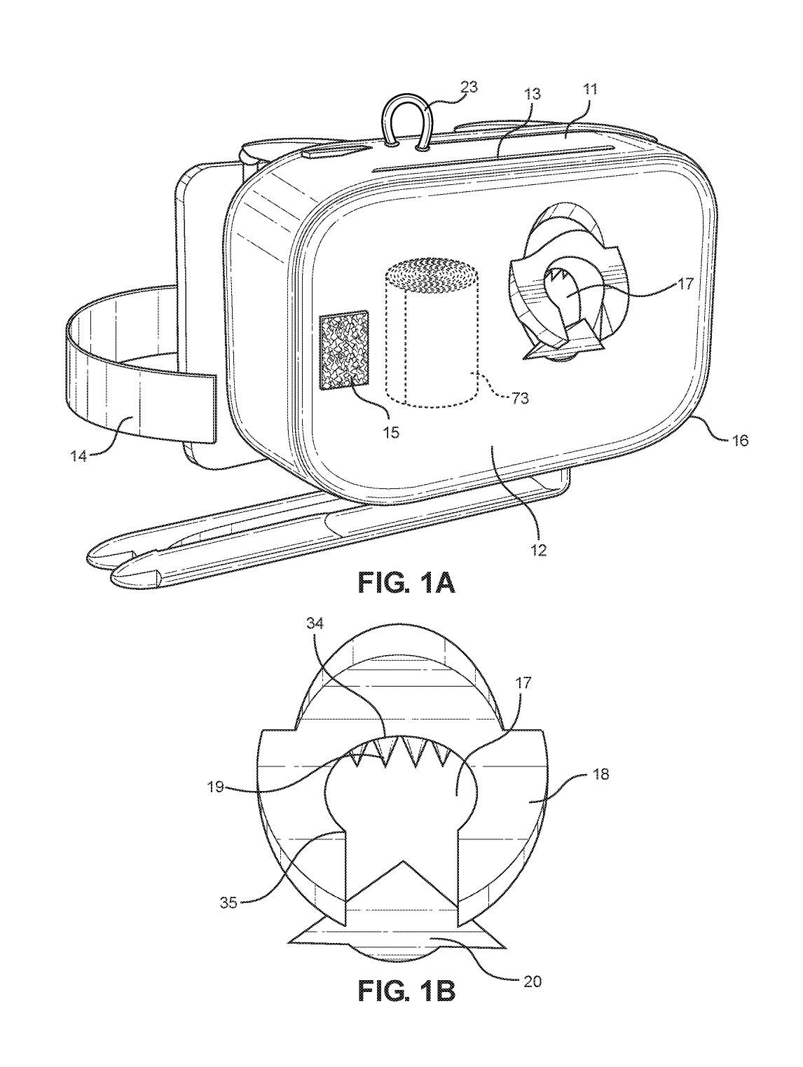

Referring now to FIG. 1A, there is shown a perspective view of a front side of an embodiment of the leash carrier utility band. The leash carrier utility band comprises a body having a top side 11, a bottom side disposed opposite the top side 11, a front side 12 disposed between the top side 11 and the bottom side, and a back side disposed opposite the front side 12. One or more straps 14 is disposed on any one side of the body, wherein the strap 14 is configured to removably secure to the opposing side via a fastener 15. In this way, the body is configured to enclose an object, such as a hand or a leash, therein. In the illustrated embodiment, the strap 14 is disposed on the back side of the body and wraps between the back side and front side 12 to removably secure to the front side 12 via the fastener 15. In the shown embodiment, the strap 14 secures via hook and loop, however, in other embodiments additional fasteners such as snaps, are used for the fastener 15.

In the shown embodiment, an elastomeric loop 23 is disposed on the top side 11 of the body. The elastomeric loop 23 is composed of elastomeric material, such that it can be stretched to fit an object, such as a flashlight, therein. In this way, a user can affix the flashlight or other object inside the elastomeric loop 23 without concern that holding the flashlight will cause them to drop the leash carrier utility band.

A bag pouch 16 is disposed on the front side 12 of the body. The bag pouch 16 can be formed integral to the body or can be protruding therefrom. In the illustrated embodiment, the bag pouch 16 fully comprises the front side 12 of the body, however in other embodiments an interior volume of the bag pouch 16 is formed between an exterior wall thereof and an exterior surface of the body. In the shown embodiment, the bag pouch 16 has an opening 13 that is resealable, thereby allowing a user to refill the bag pouch 16 when it is empty. This resealable nature can be accomplished with a hook and loop fastener disposed on the opening 13, or via any other suitable secure means, such as adhesive or a zipper. In the illustrated embodiment, the opening 13 is disposed on the top side 11 of the body, however in other embodiments, the opening 13 can face any direction of the body. The bag pouch 16 is configured to house a plurality of pet fecal matter receptacles 73, e.g. a bag, which can be removed from the bag pouch 16 via a bag dispensing aperture 17 disposed on an exterior surface of the bag pouch 16.

Referring now to FIG. 1B, there is shown a close-up view of an embodiment of the bag opener and bag dispensing aperture on the leash carrier utility band. The bag dispensing aperture 17 is annularly shaped, and operably connected to the interior of the bag pouch, such that the receptacles stored within the bag pouch can be accessed via the bag dispensing aperture. In one embodiment, a plurality of teeth 19 are disposed on a portion of the bag dispensing aperture 17. The plurality of teeth 19 are configured to aid a user in separating a single receptacle from the plurality of receptacles stored within the bag pouch. In the shown embodiment, the plurality of teeth 19 are disposed on an upper portion of a perimeter of the bag dispensing aperture 17, wherein the upper portion of the perimeter is closest to the top side of the body. The plurality of teeth 19 disposed on the upper portion of the perimeter allow the user to pull upwards on the receptacle to be dispensed and separate a single receptacle from a roll of receptacles. In this way, the plurality of teeth 19 are angled inwards towards the center of the bag dispensing aperture 17, such that the plurality of teeth 19 can separate the receptacle more easily.

In an additional embodiment, a rear side of a bag opener 18 is disposed flush against the perimeter of the bag dispensing aperture 17 and configured to further aid the user in pulling forth a single receptacle. The bag opener 18 is additionally configured to aid the user by opening the receptacle when it is pulled through the bag dispensing aperture 17. In the shown embodiment, a portion of the bag opener 18 is U-shaped, having an apex 34 and an opening 35 disposed opposite the apex 34. The bag opener 18 is disposed such that the apex 34 is aligned with the plurality of teeth 19 and is slanted to allow the user to pull forth one side of the receptacle further than the opposing side of the receptacle. Additionally, the bag opener 18 comprises a protrusion 20, that is also slanted and disposed at an angle perpendicular to the angle of the bag opener 18, such that it intersects with the opening 35. In this way, the bag opener 18 can retain a piece of a receptacle in a single position, while a user pries open the fecal matter receptacle with the hand not housed in the leash carrier utility band.

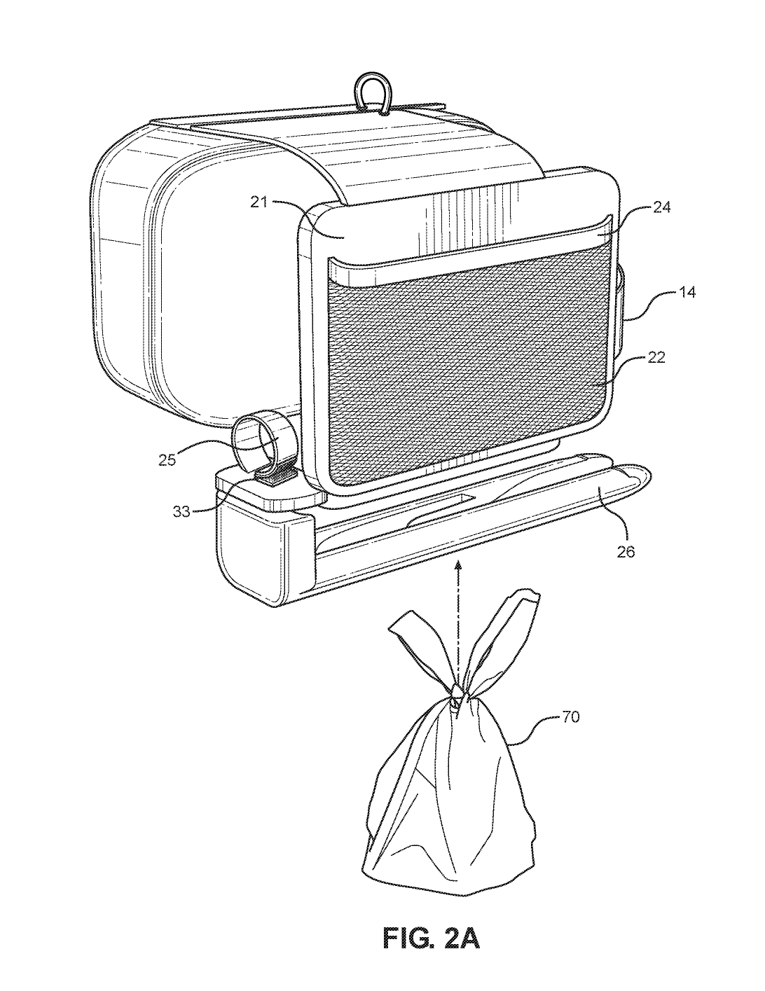

Now referring to FIG. 2A and FIG. 2B, there is shown a perspective view of a back side of an embodiment of the leash carrier utility band, and a close-up view of the bag clip, respectively. An alternate pouch 22 is disposed on a back side 21 of the body. Similar to the bag pouch disposed on the opposite side of the body, the alternate pouch 22 can be formed integral to the body or can be protruding therefrom. In the illustrated embodiment, the alternate pouch 22 fully comprises the back side 21 of the body, however in other embodiments an interior volume of the alternate pouch 22 is formed between an exterior wall thereof and an exterior surface of the body. In the shown embodiment, the alternate pouch 22 has an opening 24 that is resealable, thereby allowing a user to place objects within the alternate pouch 22. This resealable nature can be accomplished with a hook and loop fastener disposed on the opening 24, or via any other suitable secure means, such as adhesive. In the illustrated embodiment, the opening 24 faces a direction of the top side of the body, however in other embodiments, the opening 24 can face any direction of the body. In the shown embodiment, the alternate pouch 22 comprises a mesh covering. The alternate pouch 22 is configured to house a plurality of household items, such as keys or pepper spray, which can be viewed through the mesh covering without opening the alternate pouch 22.

A loop 25 is disposed at the bottom side of the body, disposed on an edge between the front side and the back side 21. The loop 25 comprises one end that is permanently secured to the body on one end and removably secured to the body on an opposing end via a fastener 33. In the shown embodiment the fastener 33 comprises a hook and loop fastener, however in other embodiments any suitable durable fastener, such as snaps, can be used. In this way, the loop 25 is configured to accept a leash therethrough, thereby allowing a user to hold the leash while wearing the leash carrier utility band.

A bag clip 26 is affixed to a bottom side of the body, wherein the bag clip 26 has an opening at one end. In the shown embodiment, the bag clip 26 comprises a hook 28 disposed along an inner portion of the bag clip 26, wherein the hook 28 is parallel to the bag clip 26 having an opening opposite the opening of the bag clip 26 itself. The hook 28 is configured to hold a used receptacle 70, such that once the user has tied together the ends of the used receptacle 70 thereby forming a knot, the bag clip 26 is configured to accept one or more used pet fecal matter receptacles 70 placed at the hook 28, and securely hold the used receptacle 70 at the tied knot such that the handles of the used receptacle 70 are above the bag clip 26 and the remainder of the receptacle 70 is below the bag clip 26. The bag clip 26 is configured to securely hold the used receptacle 70 until the user is at a trash can to throw away the used receptacle 70. In certain embodiments, the bag clip 26 is secured to a rigid base, wherein the rigid base is secured to the bottom side of the body, thereby reducing the flex of the bag clip 26 due to the weight of a used pet fecal matter receptacle being suspended from the bag clip 26.

Additionally, in the illustrated embodiment the bag clip 26 comprises a pair of protrusions 27 in a pincer configuration and biased towards one another. The pair of protrusions 27 are configured to provide additional aid when attempting to open an unused pet fecal matter receptacle by acting as a pair of surrogate hands, thereby allowing the user to affix a portion of the unopened receptacle to one of the protrusions 27, such that the user can open the receptacle with the hand not holding the leash carrier utility band. Further, the pair of protrusions 27 are configured to aid the user in tying the used receptacle using the hand not currently wrapped in the leash carrier utility band.

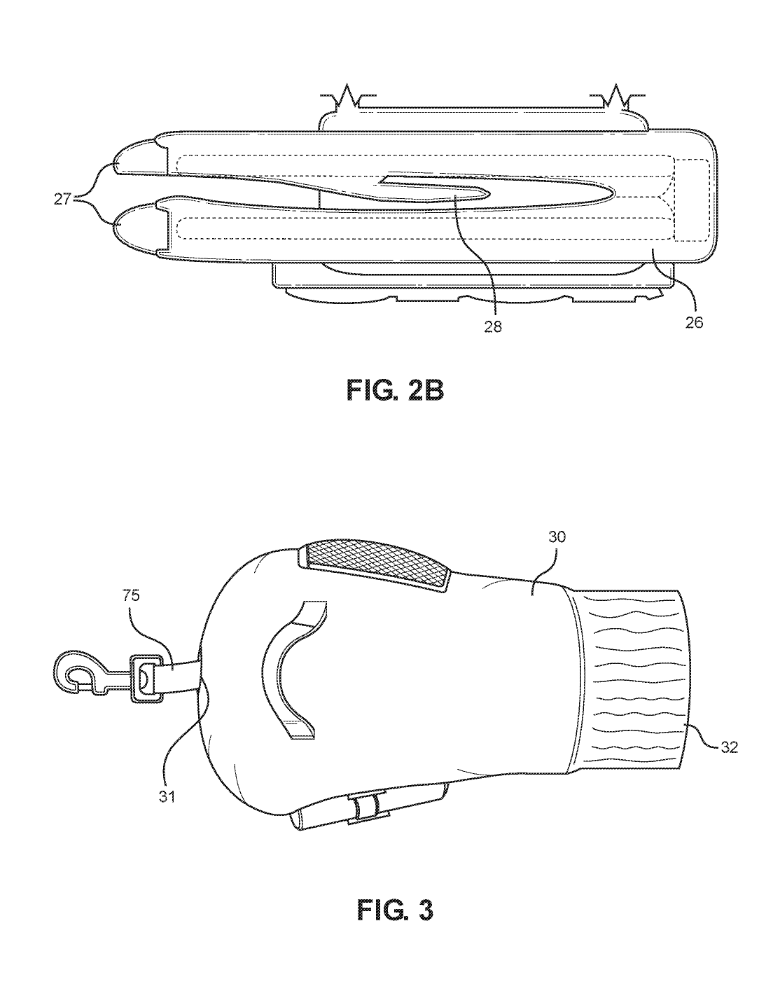

Now referring to FIG. 3, there is shown an alternate embodiment of the leash carrier utility band. In the illustrated embodiment, the body is extended such that the body is configured to enclose a hand therein. In this way, a mitten 30 is thereby formed, wherein the mitten 30 further comprises a wrist opening 32 at one end. In the illustrated embodiment, the wrist opening 32 is an elastic wrist opening composed of an elastic band or a plurality of elastic bands or fibers. In this way, the wrist opening 32 forms and secures to a user's wrist. The mitten 30 comprises an adequate interior volume configured to contain both a hand of a user and a handle of a leash 75 therein. In the present embodiment, the interior surface of the mitten 30 is constructed of a soft cloth material and the exterior surface is constructed of a weatherproof material.

In the illustrated embodiment, the mitten 30 further comprises an aperture 31 disposed at a distal end of the mitten, wherein the distal end is opposite the wrist opening 32. A leash 75 or lead can be threaded through the aperture 31, wherein a handle of the leash 75 can be held within the mitten 30 by a user, thereby allowing the leash 75 to extend through the aperture 31. In this way, a user can use a leash 75 attached to a dog to walk the dog without removing their hand from the mitten 30.

In operation, a user will utilize one or more straps disposed on the leash carrier utility band to wrap the leash carrier utility band around an object, such as their hand or a leash. To secure the leash carrier utility band around their hand, the user will utilize the fastener disposed on one side of the body of the leash carrier utility band to affix the strap across the body and around the hand. The user will then receive a leash through the loop disposed on a bottom end of the body and affix the leash to an animal, such as a dog. Once the dog defecates, the user will pull forth a pet fecal matter receptacle through the bag receiving aperture from the bag pouch. In one embodiment, the bag opener will aid the user in opening the receptacle. Once the user has placed the fecal matter in the pet fecal matter receptacle, the user will then utilize the hook of the bag clip to help tie the receptacle and place the used receptacle bag into the bag clip. In this way, a user can easily pull out a bag to clean up the fecal matter of their dog with one hand, thereby allowing them to continue holding the leash with the other hand.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A leash carrier utility band, comprising:
a body having a top side, a bottom side disposed opposite the top side, a front side disposed between the top side and the bottom side, and a back side disposed opposite the front side;
wherein one or more straps is disposed on any one side of the body and configured to removably secure via a fastener to an opposing side, such that the body is configured to enclose an object therein;
a bag clip having an opening at one end and affixed to the bottom side of the body, wherein the bag clip is configured to secure a used pet fecal matter receptacle thereto;
a loop disposed at a distal end of the bag clip, wherein the distal end of the bag clip is opposite the opening of the bag clip, wherein one end of the loop is removably securable to the body, and the loop is configured to accept a leash therethrough;
a bag pouch disposed on a front side of the body configured to house a plurality of unused pet fecal matter receptacles;
a bag dispensing aperture affixed to an outer surface of the bag pouch and in communication with an interior of the bag pouch;
an alternate pouch disposed on a back side of the body.

2) The leash carrier utility band of claim 1, wherein the bag dispensing aperture is annularly shaped, having a plurality of teeth disposed on an inner perimeter of the bag dispensing aperture.

3) The leash carrier utility band of claim 2, further comprising:
a bag opener comprising a U-shaped face having a width and disposed flush against the bag dispensing aperture and protruding outward from the bag dispensing aperture at an angle;
wherein an apex of the U-shaped face is aligned with the teeth of the bag dispensing aperture;
a slanted protrusion angled perpendicular to the front face of the bag opener such that the protrusion intersects with an opening of the U-shaped face;
wherein the bag opener is configured to separate a receptacle from a roll of receptacles and thereby open the receptacle when one is pulled from the bag pouch through the bag dispensing aperture.

4) The leash carrier utility band of claim 1, wherein the bag pouch comprises a resealable opening along a portion of a perimeter of the bag pouch.

5) The leash carrier utility band of claim 1, wherein the alternate pouch comprises a mesh covering.

6) The leash carrier utility band of claim 1, wherein the alternate pouch comprises a resealable opening along a portion of a perimeter of the bag pouch.

7) The leash carrier utility band of claim 1, wherein the bag clip comprises two protrusions in a pincer configuration biased towards one another, wherein the protrusions are configured to provide further aid to a user in opening an unused pet fecal matter receptacle.

8) The leash carrier utility band of claim 7, wherein a hook is disposed on an inner portion of the bag clip, having an opening opposite the opening of the bag clip, such that the hook is configured to secure an end of a used pet fecal matter receptacle thereto.

9) The leash carrier utility band of claim 1, wherein an elastomeric loop is disposed on the top side of the body, composed of an elastomeric material, and configured to secure an object therein.

10) The leash carrier utility band of claim 1, wherein the body is extended such that the body is configured to enclose a hand therein thereby forming a mitten, having a wrist opening at one end.

11) The leash carrier utility band of claim 10, wherein an aperture is disposed at a distal end of the body and configured to accept the leash therethrough, wherein the distal end of the body is opposite the wrist opening.

12) The leash carrier utility band of claim 10, wherein the wrist opening is elastomeric and configured to encircle a wrist of a user.
